(19) United States
(12) Patent Application Publication
(10) Pub. No.: US 2025/0042074 A1
(43) Pub. Date: Feb. 6, 2025

(54) PARISON DIRECTIONAL CANOPY FOR A BLOW/FILL/SEAL MACHINE

(71) Applicant: Weiler Engineering Inc., Elgin, IL (US)

(72) Inventors: Andrew W. Goll, Woodstock, IL (US); Paul Novorolsky, DeKalb, IL (US); Juan J. Banuelos, McHenry, IL (US)

(73) Assignee: Weiler Engineering Inc., Elgin, IL (US)

(21) Appl. No.: 18/229,374

(22) Filed: Aug. 2, 2023

(51) Int. Cl. B29C 48/27; B29C 49/04; B29C 49/46

(52) U.S. Cl. CPC B29C 48/274; B29C 49/04; B29C 49/46; B29C 2049/4679

(57) ABSTRACT

A gas dispensing canopy positionable over open parisons in a Blow/Fill/Seal machine prior to container forming, filling and sealing minimizes likelihood of particulate contamination of open parisons while the open parisons are transported to a container forming, filling and sealing station.

### FIELD OF INVENTION

This invention relates to Blow/Fill/Seal technology, and in particular to a protective device for extruded parisons in a Blow/Fill/Seal machine.

### BACKGROUND OF THE INVENTION

Blow/Fill/Seal (“B/F/S”) technology is a preferred technology for aseptic packaging of pharmaceutical and healthcare products. This packaging is a multi-step process of blow molding an extruded parison, forming a container, aseptically filling the formed container, and hermetically sealing the container in a single sequential operation in an automated machine. A thermoplastic material is heat extruded between mold parts, continuously in a tubular shape, through a circular throat to form a hanging tube referred to as a parison. When the extruded tube (parison) reaches a desired length, the mold closes around the parison and the parison is cut from the extruder. The bottom portion of the parison is pinched closed and the top is held open and in place with a set of holding jaws that are part of a mold assembly. The closed mold containing the parison is then transferred to a forming, filling and sealing station by a mold carriage.

Cutting of the parison usually involves the use of a heated moving cutter such as a hot wire or hot knife which melts through and severs the parison. A potential disadvantage associated with the use of a hot wire or the like expedient is the risk inherent in the generation or creation of parison particulates or vapor during the severance process and the deposit thereof within the interior of the ultimately formed, filled and sealed container.

The present invention provides a device and method which greatly reduces the likelihood of contaminant particulates entering into a severed parison portion during the Blow/Fill/Seal process.

### SUMMARY OF THE INVENTION

A parison canopy in a Blow/Fill/Seal machine directs a protective gaseous envelope or curtain over open ends of extruded parisons and minimizes likelihood of particulate contamination during transfer to the filling and sealing process.

The parison canopy is adapted for attachment to the Blow/Fill/Seal machine between the parison extruder head and the fill station. The parison canopy provides a protective environment for extruded parisons prior to forming, filling and sealing and includes an elongated housing having a closed end and an open end. The housing defines a plenum chamber in a closed end portion of the housing and a gas distribution chamber separated from the plenum chamber by a perforated baffle plate. A protective gas inlet for the plenum chamber is provided in the closed end portion of the housing, and a protective gas outlet is provided at the open end of the housing.

### BRIEF DESCRIPTION OF THE DRAWINGS

In the drawings,

FIG. 1 is a fragmentary side elevation of a B/F/S machine showing the location of a parison canopy embodying the invention between a parison extruder head and an adjacent filing station in a B/F/S machine;

FIG. 2 is a side elevation of a parison canopy embodying the invention and mounted to the cover of the filling station;

FIG. 3 is an enlarged side elevation view of the parison canopy of FIG. 2 facing the parison extruder head;

FIG. 4 is a side elevation view of the parison canopy shown in FIGS. 2 and 3;

FIG. 5 is an enlarged fragmentary elevation view of the parison canopy of FIG. 2; and

FIG. 6 is a sectional view of FIG. 5 taken along plane 6-6 in FIG. 5.

### DETAILED DESCRIPTION OF PREFERRED EMBODIMENTS

This invention may be used in many different forms. The specification and the accompanying drawings disclose only exemplary embodiments of the present invention. The invention is not to be limited to the embodiments illustrated, however.

The precise shapes and sizes of the components herein described are not essential to the invention unless otherwise indicated.

For ease of description, the device and method of this invention will be described in the normal (upright) operating position. Terms such as upper, lower, horizontal, etc., will be used in reference to this position. It will be understood, however, that the device of this invention may be manufactured, stored, transported, used, and sold in an orientation other than the position described.

The device of this invention can be utilized with the B/F/S machine disclosed in U.S. Pat. No. 4,707,966 to Weiler et al. The disclosures therein are incorporated herein by reference to the extent that such disclosures are pertinent and not inconsistent with the present specification.

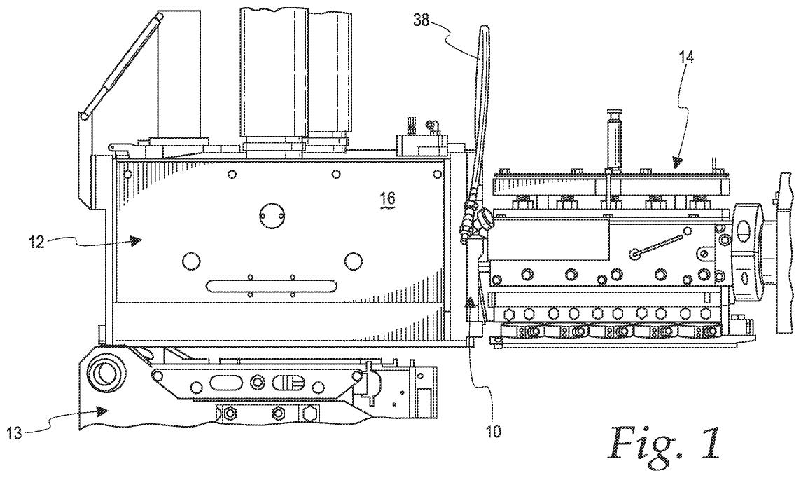

Referring to FIG. 1, parison canopy 10 is shown situated between filling station 12 of a B/F/S machine and parison extruder head 14. Mold carriage 13 that carries parisons from extruder head 14 to filling station 12 is shown below filling station 12. Parison canopy 10 is operably connected to protective gas supply hose 38 and will be discussed in greater detail hereinafter.

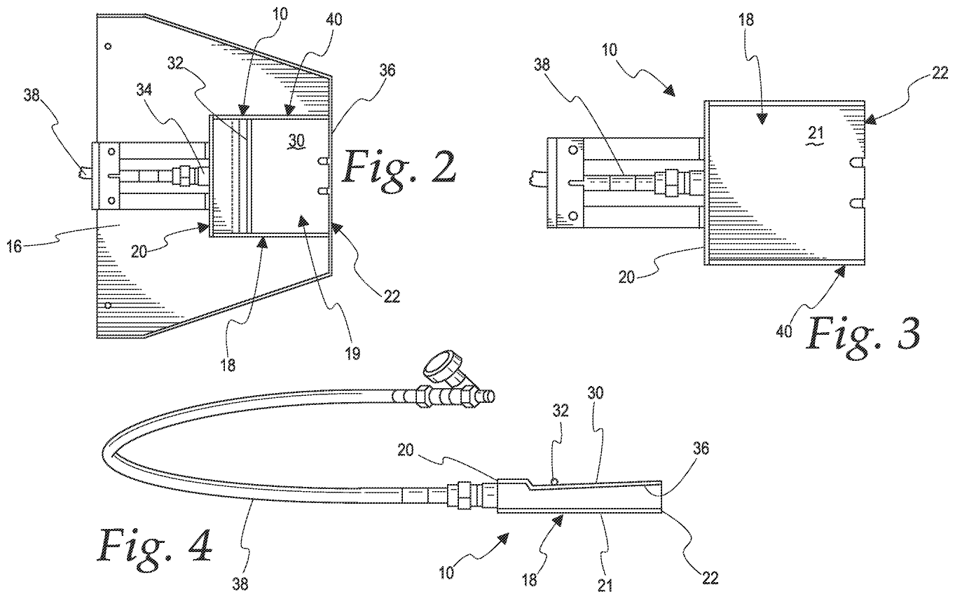

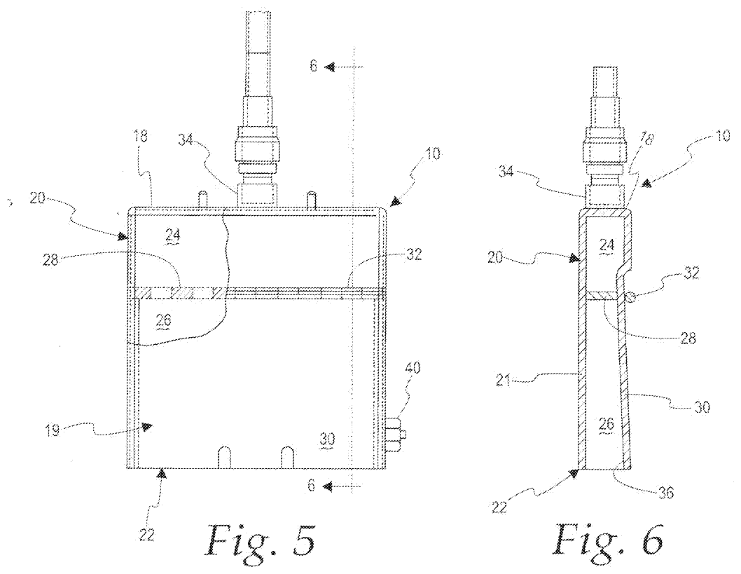

FIG. 2 shows parison canopy 10 mounted to filling station cover 16. As seen in FIG. 2, and also in FIGS. 3-6, parison canopy 10 is an elongated housing 18 having closed end 20 and open end 22. Perforated baffle 28, best seen in FIGS. 5 and 6, is provided in housing 18, spaced from closed end 20 and together a closed end portion of the housing defines plenum chamber 24. Perforated baffle 28 also serves as a back pressure generating device for parison canopy 10. During operation, a back pressure usually in the range of about 10 to about 15 pounds per square inch is provided, and protective gas velocity exiting the parison canopy at the open end usually is in the range of about 20 feet per second to about 30 feet per second.

Housing 18 defines a gas distribution chamber 30 downstream from baffle 28 and terminates in protective gas outlet 36. Protective gas, such as sterilized air or sterilized nitrogen and the like is supplied to plenum chamber 24 via gas inlet 34 and gas supply hose 38.

A particle monitor, capable of detecting 0.5 micron particles can be provided below protective gas outlet 36, if desired.

In elongated housing 18, front wall 19 and back wall 21 (FIGS. 3, 4 and 6) can be solid plates. Alternatively, a portion of front wall defining gas distribution chamber 26 can be a hinged plate 30 held in place by hinge 32 as shown in FIGS. 5 and 6. Lock 40 in a side wall of elongated housing 18 can be provided to fix the hinged plate 30 in a predetermined position relative to the protective gas outlet. In this manner, the velocity of the protective gas stream exiting the parison canopy can be conveniently adjusted, if desired.

The foregoing description and drawings are illustrative embodiments of the invention, but are not to be taken as limiting. Still other variants within the spirit and scope of this invention are possible and will readily present themselves to those skilled in the art.

1. A parison canopy adapted for positioning in a gap between a parison extruder head and a fill station adjacent to the parison extruder head in a Blow/Fill/Seal machine which comprises
an elongated housing having a closed end and an open end;
a perforated baffle plate in the housing, spaced from the closed end, defining a plenum chamber at a closed end portion of the housing and a protective gas distribution chamber downstream for said baffle plate;
a protective gas inlet defined in the closed end portion and a protective gas outlet defined at said open end.

2. The parison canopy in accordance with claim 1 wherein the housing has a hinged swing plate in a wall portion of the housing defining the protective gas distribution chamber.

3. The parison canopy in accordance with claim 2 having a swing plate lock mounted to a wall portion of the housing which defines said gas distribution chamber and operably associated with the swing plate so as to keep the swing plate at a predetermined position relative to the protective gas outlet.
